(19) United States
(12) Patent Application Publication
(10) Pub. No.: US 2016/0291915 A1
(43) Pub. Date: Oct. 6, 2016

(54) DISPLAY SHARING SESSIONS BETWEEN DEVICES

(71) Applicant: Airwatch LLC, Atlanta, GA (US)

(72) Inventors: RAMANI PANCHAPAKESAN, Bangalore (IN); AKSHAY LAXMINARAYAN, Bangalore (IN); USHA KAMATH, Bangalore (IN); SUMAN DAS, Bangalore (IN)

(21) Appl. No.: 14/745,487

(22) Filed: Jun. 22, 2015

(30) Foreign Application Priority Data
Mar. 31, 2015 (IN) 1721/CHE/2015

(51) Int. Cl. G06F 3/14; G06F 3/01

(52) U.S. Cl. CPC G06F 3/1423; G06F 3/017

(57) ABSTRACT

Disclosed are various embodiments for facilitating a display sharing session between a host device and one or more viewer devices. Content rendered by a host application to which viewer applications also have access can be accessed in connection with a display sharing session. Navigation commands or notation commands can be generated by the host application in response to user input received by the user and executed by the viewer application to facilitate the display sharing session.

### RELATED APPLICATIONS

Benefit is claimed under 35 U.S.C. 119(a)-(d) to Foreign application Serial No. 1721/CHE/2015 filed in India entitled “DISPLAY SHARING SESSIONS BETWEEN DEVICES”, on Mar. 31, 2015, by AIRWATCH LLC, which is herein incorporated in its entirety by reference for all purposes.

### BACKGROUND

Sharing of content on a display between devices can be useful, for example, in a classroom or instructional setting as well as in any other setting in which screen or document sharing for collaborative or other purposes is desired. For example, an instructor may wish to share a document or other content displayed on a computing device with students in the classroom who may have their own devices. Additionally, the instructor may wish to notate or navigate through the document or other content such that the notation or navigation input is also reflected on the devices of the students.

One solution for sharing display of a particular document may involve sending image or video data corresponding to all or a portion of the display of a host device to the various viewer devices. In other words, a host device can transmit image or video data corresponding to what is shown on a display of the host device or a window within an application executed by the host device to the viewer devices. The viewer devices can then render the image data or video data on respective displays of the viewer devices. Such a solution can be bandwidth and computationally intensive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example scenario according to various embodiments of the present disclosure.

FIG. 2 is a drawing of a networked environment according to various embodiments of the present disclosure.

FIGS. 3-4 are drawings of an example scenario according to various embodiments of the present disclosure.

FIGS. 5-8 are flowcharts illustrating an example of functionality implemented by components executed in the networked environment of FIG. 2 according to various embodiments of the present disclosure.

### DETAILED DESCRIPTION

The present disclosure relates to facilitating the sharing of content on the display of a computing device associated with a first user, such as a class instructor or meeting host, with the display of one or more other computing devices associated with other users, such as students in a classroom setting or meeting participants. In one example, a computing device of an instructor or meeting host, which is an example of a host device, has access to a particular document, file or other type of content. The one or more computing devices associated with students or meeting participants, which are examples of viewer devices, also have access to a copy of the same document, file or other content as the host device. Accordingly, a host device can initiate a display sharing session in connection with a particular file to which the viewer devices also have access.

An example of the present disclosure involves a host device and viewer devices having access to and/or viewing the same content. In one example, the content is viewed by the host device and viewer devices using the same application executed on the devices. In another examples, the host device and viewer devices is accessed by the devices using different applications, where one application executing at the host device can serve as a master to a slave application executed at the viewer device. To facilitate sharing of a display of the content, the host device can initiate a display sharing session that instructs the viewer devices to open the same content on the viewer devices. Then, the host device can generate navigation commands that instruct the viewer devices with respect to a portion of the content that should be rendered by the viewer devices in response to user input received by the host device, such as from an instructor or a meeting host. The host device can also generate notation commands that correspond to notation of the content on the host device, such as gesture notation, text input, or other types of input, which can be transmitted to and rendered by the viewer devices. In this way, instead of transmitting image data or video data corresponding to changes in the content displayed on the host device, the host device can transmit, for example, navigation or notation commands to viewer devices. Navigation or notation commands, as described below, can instruct a viewer device to navigate to a specified portion of a piece of content or render a notation on the content in the viewer devices. Accordingly, the resultant view on the viewer device can be equivalent to what would be achieved by sending the image or video data during navigation. Navigation or notation commands can also require less bandwidth and be less computationally intensive than transmitting image or video data corresponding to what is displayed on a display of the host device to the viewer devices involved in a display sharing session.

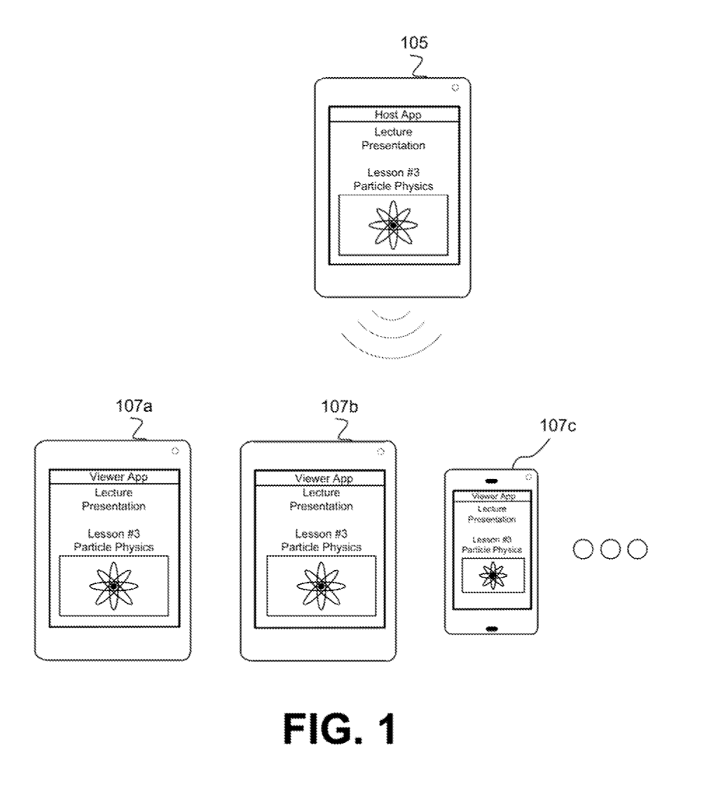

As shown in the example scenario of FIG. 1, a host device 105 can host a display sharing session in which content shown or rendered by the host device 105 is also shown or rendered by one or more viewer devices 107a, 107b, 107c. In the scenario shown in FIG. 1, the host device 105 has access to the content shown in a host application executed by the host device 105. The viewer devices 107a, 107b, 107c also have access to the content rendered by a viewer application executed by the viewer device 107. As an instructor provides input captured by the host application that reflects navigation through or notation of the content shown in the host application, the host device 105 generates respective navigation commands or notation commands. The navigation or notation commands are transmitted to the viewer devices 107a, 107b, 107c, which can execute the commands so that the content shown in a viewer device 107 corresponds to that which is displayed by the host application. In other words, navigation commands and notation commands can cause a viewer device 107 to modify the displayed content.

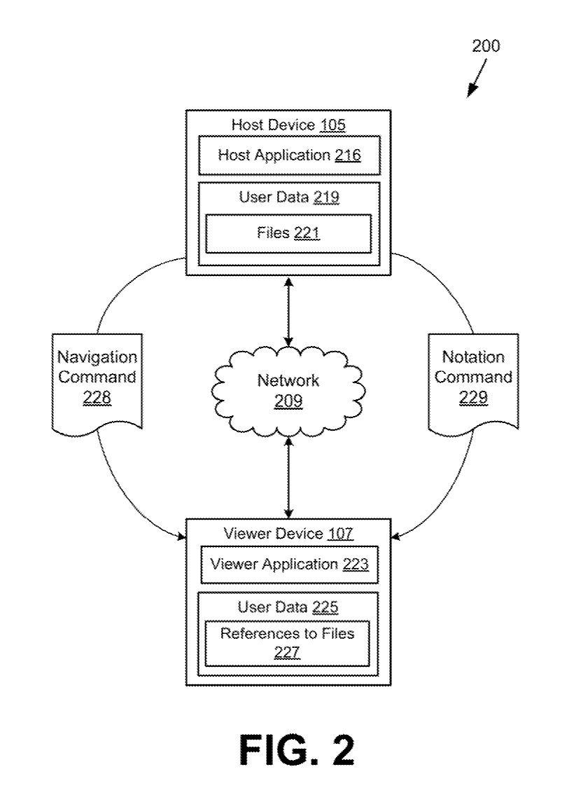

With reference to FIG. 2, shown is a networked environment 200 according to various embodiments. The networked environment 200 includes a host device 105 and at least one viewer device 107, which are in data communication over a network 209. The network 209 includes, for example, the Internet, one or more intranets, extranets, wide area networks (WANs), local area networks (LANs), wired networks, wireless networks, other suitable networks, or any combination of two or more such networks. For example, such networks can include satellite networks, cable networks, Ethernet networks, telephony networks, and other types of networks. FIG. 2 illustrates one host device 105 in communication with a viewer device 107 merely for illustrative purposes. It should be appreciated that the illustrated devices can be deployed in various ways and that the depicted illustration is non-limiting.

The host device 105 is representative of one or more computing devices that can be associated with a user or organization. The host device 105 can be associated with a particular user account associated with an organization, such as an enterprise, university, or any other organization. The host device 105 can also be enrolled with an enterprise mobility management (EMM) server or system that provides device management capabilities as well as access to enterprise data, such as electronic mail, contacts, documents, files, or other resources. Enterprise data can be synchronized between an EMM server or system and the host device 105 such that the host device 105 has access to certain files or documents to which a user associated with a particular user account can access using the host device 105. The EMM server or system can also be configured with the capability to disable access to certain files or documents as well as issue commands to the host device 105 that are executed by an application executed by the host device 105 and/or operating system components of the host device 105. For example, an EMM server can issue a command to wipe or erase data from the host device 105 in response to violation of a compliance rule or any other condition, which can be carried out by the host device 105. As another example, a user account can have access to a file that is associated with a unique identifier within a file storage service accessible through the network 209. The file can be stored by or on the host device 105 and accessible through an application on the host device 105 that authenticates a user's access to the file such as be using a user account identifier and password.

A host device 105 can include, for example, a processor-based system, such as a computer system, that can be embodied in the form of a desktop computer, a laptop computer, a personal digital assistant, a cellular telephone, a smartphone, a set-top box, a music player, a tablet computer system, a game console, an electronic book reader, or any other device with like capability. The host device 105 can include one or more displays that are integrated within or in communication with the host device 105, such as a liquid crystal display (LCD) display or other types of display devices. The host device 105 can also be equipped with networking capability or networking interfaces, including a localized networking or communication capability, such as a NFC capability, RFID read and/or write capability, a microphone and/or speaker, or other localized communication capability.

The viewer device 107 is representative of one or more computing devices that can be associated with a user or organization. The viewer device 107 can also be associated with a particular user account associated with an organization, such as an enterprise, university, or any other organization. As one example, the viewer device 107 can be linked with As in the case of the host device 105, the viewer device 107 can also be enrolled with an EMM system that provides management capabilities with respect to the viewer device 107 as well as access to enterprise data, such as electronic mail, contacts, documents, files, or other resources. In one example, more than one viewer device 107, each of which correspond to a student in a classroom setting or meeting participants, can be in communication with a host device 105 to effectuate a display sharing session in which content shown within a display or a window of the host device 105 is also shown in a display or window of the viewer devices 107.

A viewer device 107 can also comprise, for example, a processor-based system, such as a computer system, that can be embodied in the form of a desktop computer, a laptop computer, a personal digital assistant, a cellular telephone, a smartphone, a set-top box, a music player, a tablet computer system, a game console, an electronic book reader, or any other device with like capability. The viewer device 107 can also include one or more displays that are integrated within or in communication with the host device 105 as well as networking capability or networking interfaces, including a localized networking or communication capability, such as an NFC capability, RFID read and/or write capability, a microphone and/or speaker, or other localized communication capability.

The host device 105 can be configured to execute various applications, such as a host application 216 and other applications, services and the like. The host application 216 can be executed to facilitate a display sharing session in which content displayed by the host device 105 and one or more viewer devices 107 with which a display sharing session is maintained. The host application 216 can access content to which the host device 105 or a user account associated with the host device 105 has access and can initiate a display sharing session with various viewer devices 107. As will be described below, the host application 216 can also facilitate broadcasting or sharing of content that is displayed or shown to the user of the host device 105 and users of viewer devices 107.

The host device 105 can also store user data 219, which can include one or more files 221 or references to files 221 of a user account associated with the host device 105. User data 219 can also include email data, contacts, calendar data, or other data that can be synchronized with or stored on the host device 105. In one example, the host application 216 can facilitate a display sharing session involving a file 221 that is displayed by the host application 216, where the file 221 is associated with the user account associated with the host device 105, such as an instructor, meeting host, or other type of user. Files 221 can include content such documents, media or other content. In one scenario, a user account can be associated with an enterprise or organization with which user accounts of the viewer devices 107 are also associated.

The host device 105 can also execute other applications or services that facilitate data synchronization with an EMM server or user data associated with a particular user account in the user account. The host device 105 can also execute applications or services that facilitate compliance with compliance rules enforced by the EMM server.

The viewer device 107 can be configured to execute various applications, such as a host application 216 and other applications, services and the like. The viewer application 223 can facilitate the sharing of content displayed by the host device 105 with the viewer device 107. The viewer application 223 can access content to which the viewer device 107 or a user account associated with the viewer device 107 has access to facilitate a display sharing session with the host device 105, where the display sharing session involves content to which both the host device 105 and the viewer device 107 have access. As will be described below, the viewer application 223 facilitates sharing of content that is displayed or shown to the user of the host device 105 with the viewer device 107.

The viewer device 107 can also store user data 225, which can include one or more files 221 or references to files 227 which can be associated with a user account and the viewer device 107. User data 225 can also include email data, contacts, calendar data, or other data that can be stored on the viewer device 107. User data 225 on the viewer device 107 can be synchronized with user data associated with the viewer device 107 or a corresponding user account in an EMM system or server. In one example, the viewer application 223 can facilitate displaying a file 221 displayed by the host application 216, where the file 221 can also be associated with a user account corresponding to the viewer device 107, such as a student, meeting participant, or other type of user using a display sharing session. In one scenario, a user account can be associated with an enterprise or organization with which a user account of the host device 105 is also associated. For example, an instructor and students can be associated with user accounts of a particular institution employing an EMM system in which both the host device 105 and the viewer devices 107 are enrolled. In such a scenario, the EMM system can facilitate access to a particular file that is shared between the host device 105 and viewer devices 107 in a display sharing session.

As in the case of a host device 105, the viewer device 107 can also execute other applications or services that facilitate data synchronization with an EMM server or data associated with a particular user account. The viewer device 107 can also execute applications or services that facilitate compliance with compliance rules enforced by the EMM server.

Next, a general description of the operation of the various components of the networked environment 200 is provided. To begin, a user using the host device 105, such as a classroom instructor, a meeting host, or any other type of user, can initiate a display sharing session with one or more other viewer devices 107 that are in communication with the host device 105 through the network 209. In some examples, the host device 105 can publish a reference to a display sharing session corresponding to a particular meeting or classroom session on a server to which the viewer devices 107 can have access. In some scenarios, the display sharing session can be password protected or only available to users for which an invitation is generated from the host device 105. In another scenario, users associated with a particular user group within an EMM server or a directory service can be authorized to access a display sharing session initiated by the host device 105. For example, a reference to the display sharing session can be published on a portal site or system separate from the host device 105, which can also facilitate authentication of users or authentication of a password associated with the display sharing session.

In other words, viewer devices 107 can request to join a display sharing session, be authenticated, and thereafter join the display sharing session whether the display sharing session is in progress or not. In some examples, communications facilitating a display sharing session between the host device 105 and viewer devices 107 can also be routed through an intermediary system. Accordingly, one or more viewer devices 107 can join a display sharing session that involves a direct connection to the host device 105 or a connection to an intermediary site through which communications are routed. A user of a host device 105 can initiate a display sharing session by launching the host application 216 or initiating a display sharing session from within the host application 216. In one example, a user of the host device 105 can select a file 221 to be shared with viewer devices 107 in the display sharing session.

The file 221 to be shared or viewed in a display sharing session can be pushed to viewer devices 107 upon enrollment of the viewer device 107 with an EMM server or upon a viewer device 107 joining a display sharing session. The file 221 can also be obtained directory from the host device 105 through a localized transmission, such as an NFC transmission, a Bluetooth file transfer or a peer-to-peer network file transfer. The files 221 can therefore be sent automatically or on demand.

Upon selection of a file 221 to be shared with viewer devices 107 by a user of the host device 105, the host application 216 can generate a navigation command 228 that identifies the file 221 and includes a command that the viewer application 223 open a copy of the file 221 accessible to the viewer device 107. For example, a user of a host device 105 can navigate to a folder, select a file 221 to share with the viewer devices 107, and launch the file in the host application 216. The host application 216 can generate a navigation command 228 instructing the viewer devices 107 to access a copy of the file 221 accessible to the viewer devices 107 and transmit this navigation command 228 to the viewer devices 107. The navigation command 228 can then be executed by the viewer application 223. To execute the navigation command 228, the viewer application 223 can open a copy of the file 221 associated with the display sharing session.

In some examples, the navigation command 228 can specify a particular portion of the file 221 that should be rendered upon the display of a viewer device 107 or within an application window associated with the viewer application 223. The portion of the file 221 that should be rendered on the viewer device 107 can be specified by a zoom level or an indication of which portion of the file 221 is rendered upon the display of the host device 105 by the host application 216 or within an application window associated with the host application 216. In some scenarios, upon initiation of a display sharing session by the host device 105, the host application 216 and viewer application 223 can respectively open the file 221 at a default zoom level or display a default portion of the file 221. In one scenario, the viewer application 223 can allow a user viewing the file 221 on a viewer device 107 to adjust a zoom level or navigate to a different portion of the file 221 than is displayed by the host application 216 until the host device 105 issues another navigation command 228. In another scenario, the viewer application 223 can allow a user viewing the file 221 on a viewer device 107 to adjust a zoom level or navigate to a different portion of the file 221 than is displayed by the host application 216 only for a predetermined amount of time or until the host device 105 issues another navigation command 228 to the viewer application 223.

In this way, to initiate the display sharing session, rather than transmitting image or video data corresponding to the display of the host device 105 or an application window associated with the host application 216, the host application 216 can generate a navigation command 228 that instructs the viewer application 223 to access a copy the file 221 that is rendered by the host application 216 using the reference to the file 227, where a copy of the file 221 is stored on the viewer device 107. The viewer application 223 can access a copy of the file 221 using a corresponding reference to the file 227 stored on the viewer device 107. In one example, a user account associated with the viewer device 107 can also have access to the file 221 so that the viewer application 223 can access a copy of the file 221 from an EMM server or a remote file storage location to which the viewer device 107 has access.

As the instructor or meeting host navigates through the file 221 using the host application 216, the host application 216 can capture user input from the user of the host device 105 and translate the user input into a navigation command 228 that is transmitted to the viewer application 223. For example, when the user provides input using an input device to the host application 216, such as through a touchscreen input device, a keyboard, a mouse, or any other input device, the host application 216 can capture or log the input and generate a navigation command 228 corresponding to the input. In one example, the host application 216 can employ a key logger or capture gestures provided through input devices of the host device 105 in order to capture user inputs. As one scenario, a user can provide a tap or touch gesture on a certain location on a touchscreen input device of the host device 105. The host application 216 can capture data associated with the gesture, such as a location and a tap duration of the gesture, from the host device 105 or an operating system of the host device 105. The host application 216 can then convert the input to a navigation command 228 that can be transmitted to the viewer application 223, which can execute the navigation command 228 on the viewer device 107 to update the display of the file 221 as displayed by the viewer application 223.

For example, a tap gesture can be converted into a navigation command 228 that instructs the viewer application 223 to execute a tap gesture at a certain (X, Y) coordinate within the viewer application 223. In some examples, the host application 216 can convert coordinates corresponding to the location of an input captured by the host application 216 to a relative measure that can be scaled according to a display resolution of the viewer application 223 and/or the viewer device 107. For example, the host device 105 and viewer device 107 can have varying display resolutions or a window in which the host application 216 and viewer application 223 are displayed can be of varying size. Accordingly, the host application 216 can convert coordinates corresponding to the location of an input to a relative measure that comprises a percentage of an X-axis and Y-axis, respectively. For example, a tap gesture occurring in the center of a window in which the host application 216 is rendered can be converted such that the navigation command 228 describes the gesture occurring at 50% along the X-axis and 50% along the Y-axis.

Upon receiving such a navigation command 228, the viewer application 223 can convert the relative coordinates to coordinates that are appropriate for the display resolution and/or window in which the viewer device 107 displayed the viewer application 223. A tap gesture can cause a change in the content shown in the viewer application 223 that corresponds to a change in the content shown in the host application 216. In this way, even though the display resolution of the host device 105 and viewer device 107 can vary, the inputs obtained from the user by the host application 216, when convened into a navigation command 228 and executed by the viewer application 223, are executed by the viewer application 223 such that a gesture in the same location is performed by the viewer application 223 with respect to a portion of the file 221 rendered by the viewer application 223. The viewer application 223 can execute a navigation command 228 that defines a tap gesture and update a portion of the file 221 that is displayed within the viewer application 223 on the viewer device 107.

In another example, a swipe gesture can be captured by the host application 216 and converted into a navigation command 228 that is executed by the viewer application 223. In the case of a swipe gesture captured by the host application 216, the host application 216 can generate a navigation command 228 that includes a set of beginning coordinates and a set of end coordinates corresponding to the gesture. In an alternative scenario, the swipe gesture can be embodied in a navigation command 228 as a beginning coordinate, an angular direction, and a vector, where the vector is also expressed as a relative percentage of a display of the host device 105 or a window in which the host application 216 is rendered. In one example, an EMM server can translate a navigation command 228 into an absolute beginning coordinate and end coordinate as well as an angular direction that can be executed by the viewer application 223 based upon information stored by the EMM server about the display resolution of the host device 105 and viewer device 107. Upon receiving such a navigation command 228, the viewer application 223 can execute the swipe gesture, which can cause a change in the portion of the file 221 shown within the viewer application 223. Upon execution of the navigation command 228, the viewer application 226 can update a portion of the file 221 displayed by the viewer device 107.

In another example, a pinch or unpinch gesture can be captured by the host application 216 and converted into a navigation command 228 that is executed by the viewer application 223. In the case of a pinch or unpinch gesture captured by the host application 216, the host application 216 can generate a navigation command 228 that includes a set of coordinates at which the gesture occurs and a zoom level associated with the gesture, which can express a percentage amount of an adjustment to a zoom level at which the file 221 is rendered or displayed within the viewer application 223. Upon receiving such a navigation command 228, the viewer application 223 can execute the pinch or unpinch gesture and update a portion of the file 221 displayed within the viewer device 107.

In yet another example, a rotation gesture can be captured by the host application 216 and converted into a navigation command 228 that is executed by the viewer application 223. In the case of a rotation gesture captured by the host application 216, the host application 216 can generate a navigation command 228 that comprises a set of coordinates at which the gesture occurs and an angular magnitude, which is a degree of rotation around a focal point that is the set of coordinates associated with the gesture. The rotation gesture can cause a rotation of the portion of the file 221 shown within the viewer application 223. Upon receiving such a navigation command 228, the viewer application 223 can execute the rotation gesture and update a portion of the file 221 displayed within the viewer device 107.

In another example, in response to a rotation gesture, the host application 216, the host application 216 can generate a navigation command 228 that comprises a set of coordinates at which the gesture occurs and an angular magnitude, which is a degree of rotation around a focal point that is the set of coordinates associated with the gesture. The rotation gesture can cause a rotation of the portion of the file 221 shown within the viewer application 223. Upon receiving such a navigation command 228, the viewer application 223 can execute the rotation gesture and update a portion of the file 221 displayed within the viewer device 107.

In another example, a change in the display orientation of the host device 105 can be captured by the host application 216 and converted into a navigation command 228 that is executed by the viewer application 223. In this example, the host application 216 can generate a navigation command 228 that identifies the orientation of the host device 105. The viewer application 223 can receive the navigation command 228 and update the displayed orientation on the viewer device 107 to match the orientation of the host device 105. In this way, the host device 105 and viewer device 107 can maintain a common display orientation during the display sharing session. The host device 105 can also transmit the navigation cormnand 228 containing the display orientation upon initiation of a display sharing session.

Additional examples of gestures or user inputs that can be captured by the host application 216 and converted into a navigation command 228 include a scrolling event, a page-up event, a page-down event or a command to navigate to a particular location within the file 221. The host application 216 can generate a navigation command 228 that comprises such a command. Upon receiving such a navigation command 228, the viewer application 223 can execute the command to update a portion of the file 221 displayed within the viewer device 107.

A command to render or access another file 221 is another example of a user input that can be captured by the host application 216 and converted into a navigation command 228 that is executed by the viewer application 223. For example, a user on the host device 105 can cause the viewer application 223 to access another file 221 stored on the host device 105. In such a scenario, the host application 216 can generate a navigation command 228 that identifies the file 221 accessed by the host application 216 on behalf of the user. Such a navigation command 228 can be transmitted to the viewer application 223, and the viewer application 223 can open a copy of the file 221 or a reference to the file 227 stored on or accessible to the viewer device 107.

The host application 216 can also allow a user to enter notations that are displayed within the viewer application 223. As one example, the host application 216 can capture a stroke gesture (e.g. a stroke gesture length or duration) obtained from the user that is associated with a notation of the file 217 within the host application 216. The stroke gesture can include a stroke color selected by the user and a set of coordinates corresponding to a line, an arc or a freeform stroke gesture. The stroke gesture can also include a stroke width. The host application 216 can then embed the various parameters associated with the stroke gesture into a notation command 229, which can be transmitted to the viewer device 107. The viewer application 223 can then execute the notation command 229 containing the stroke gesture parameters and draw a line, arc or freeform stroke upon the display of the host device 105 andior within a window corresponding to the viewer application 223.

Another example of a notation that can be captured by the host application 216 and displayed by the viewer application 223 is a text input. In one example, a user using the host application 216 can select an area of a display within the host application 216 and enter a text input, which can be rendered by the viewer application 223. Accordingly, the host application 216 can generate a notation command 229 that includes the text input entered by the user on the host device 105. Such a notation command 229 can also include other properties of the text input, such as a text box size, coordinates, and font. Upon receiving the notation command 229, the viewer application 223 can then execute the notation command 229 containing the text input parameters and render the text input upon the display of the host device 105 and/or within a window corresponding to the viewer application 223.

In some embodiments, navigation commands 228 and notation commands 229 can also be generated with a sequence number associated with an order in which they are generated by the host application 216. In this way, a viewer application 223 receiving a navigation command 228 and/or notation command 229 can examine a sequence number associated with a received command and ensure that the commands are executed in the order in which they are generated by the host application 216. In one example, if a navigation command 228 or notation command 229 is received out of order, the viewer application 223 can avoid executing a particular command until a missing command is received from the host application 216. In another example, the viewer application 223 can request that a missing command be re-transmitted from the host application 216 to the viewer application 223 in response to receiving a command with a sequence number that is not sequential relative to a previous command.

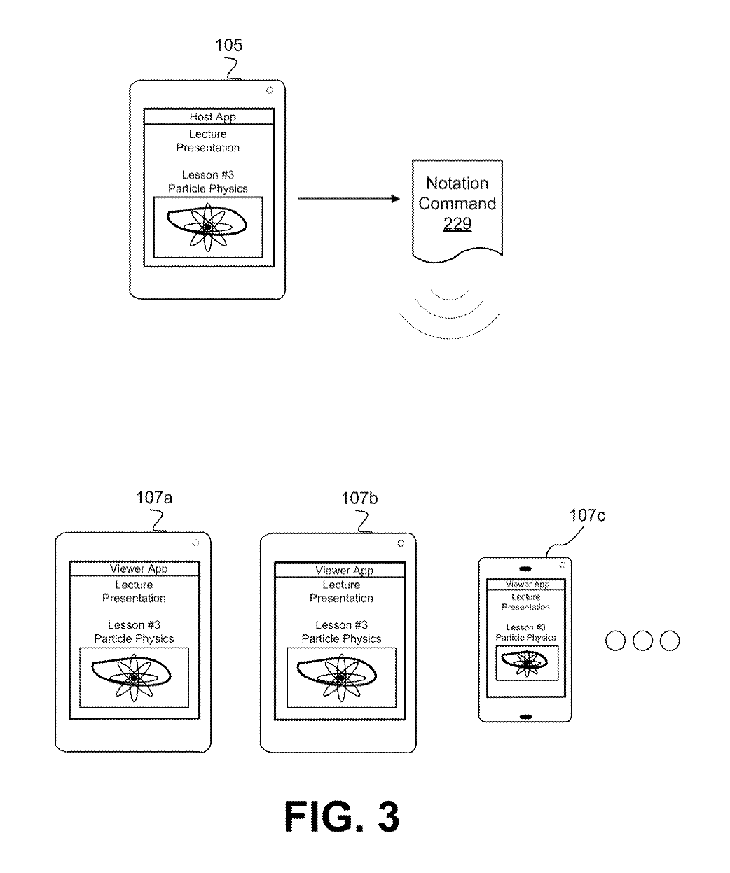

Referring next to FIG. 3, shown is an example scenario according to one embodiment. In the example of FIG. 3, a display sharing session in which a host device 105 is in communication with various viewer devices 107a, 107b, and 107c is shown. In the example of FIG. 3, the host application 216 can capture user input from a user and generate a corresponding notation command 229 reflecting the user input. The notation command 229 can be transmitted to the viewer devices 107 executing a viewer application 223, which can execute the notation command 229, causing the notation to be rendered upon the display of the viewer device 107.

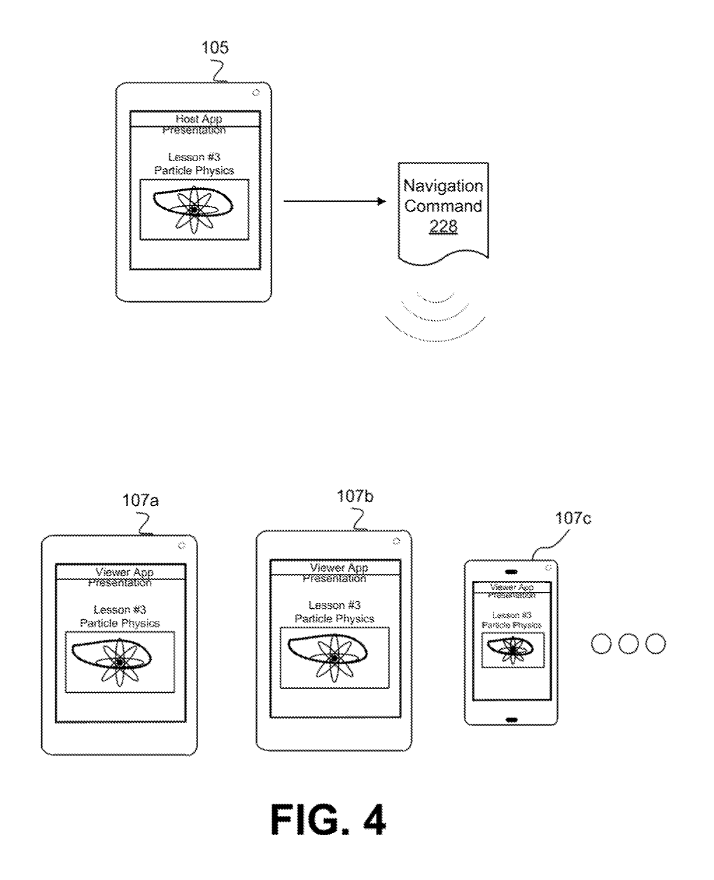

Continuing the example of FIG. 3, reference is now made to FIG. 4, which shows an alternative example scenario according to one embodiment. In the example of FIG. 4, the display sharing session in which a host device 105 is in communication with various viewer devices 107a, 107b, and 107c is again shown. In the example of FIG. 4, the host application 216 can capture user input from a user and generate a corresponding navigation command 228 reflecting the user input. The navigation command 228 can be transmitted to the viewer devices 107 executing a viewer application 223, which can execute the navigation command 228, causing the portion of the content rendered upon the display of the viewer device 107 to be updated according to the navigation input from the user of the host device 105.

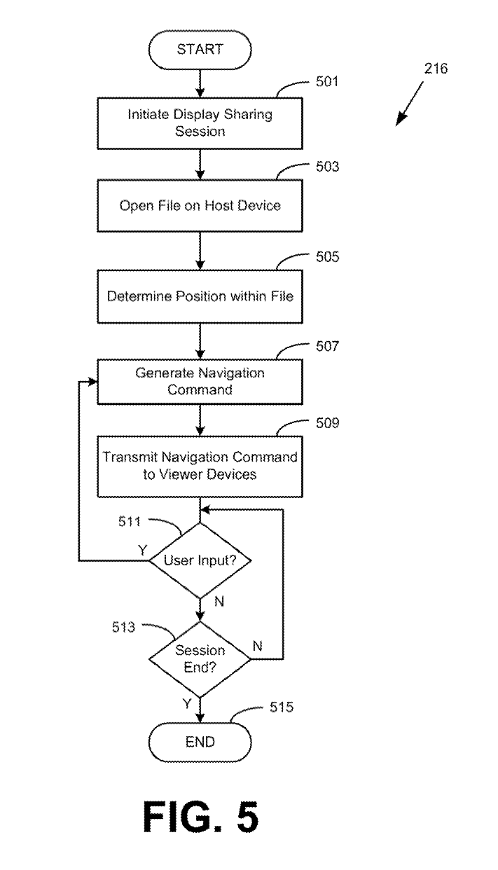

Referring next to FIG. 5, shown is a flowchart that provides one example of the operation of a portion of the host application 216 according to various embodiments. It is understood that the flowchart of FIG. 5 provides merely an example of the many different types of functional arrangements that can be employed to implement the operation of the portion of the host application 216 as described herein. As an alternative, the flowchart of FIG. 5 can be viewed as depicting an example of elements of a method implemented in the host device 105 according to one or more embodiments. Functionality attributed to the host application 216 can be implemented in a single process or application executed by the host device 105 and/or multiple processes or applications. The separation or segmentation of functionality as discussed herein is presented for illustrative purposes only.

Beginning with step 501, the host application 216 can initiate a display sharing session with one or more viewer devices 107. As discussed previously, the host device 105 and viewer devices 107 can, in one example, connect using a secure session in an EMM environment. During the session, the viewer application 223 can lock a user providing commands to the viewer application 223, ensuring that the host application 216 and viewer application 223 share a common display. The lock command can be generated by the viewer application 223 upon initiating a display sharing session or sent from the host application 216. The lock command can optionally be requested by a host and then released, allowing a host to control how and whether a viewer device 107 should process user input received from a user of the viewer device 107. If a user input received from a user of the viewer device 107 is blocked, the viewer application 107 can notify a user that entry of user inputs through the viewer device 107 has been prohibited by the host device 105. Although some embodiments can use a lock command, other implementations allow a user to continue providing navigation and other commands to the viewer application 223. In these examples, receipt of a navigation or notation command from host device 105 can override any commands separately received from a user of viewer device 107, allowing display of content by the host application 216 and the viewer application 223 to be synchronized.

The lock command can also cause the viewer device 107 to maintain a similar or identical screen orientation as the host device 105. Additionally, the lock command can also cause the viewer application 223 to disable the application switching capabilities of the viewer device 107. The user of the viewer device 107 can be prohibited from accessing other applications or content aside from the viewer application 223. The lock command can further disable the ability of a user to lock or deactivate a display of the viewer device 107 during the display sharing session. Upon ending a display sharing session, the host device 105 can issue another command that releases the lock command on the viewer device 107, which enables the disabled functionality identified above.

As discussed above, the viewer application 223 can allow a user viewing the file 221 on a viewer device 107 to adjust a zoom level or navigate to a different portion of the file 221 than is displayed by the host application 216 until the host device 105 issues another navigation command 228. Additionally, viewer application 223 can allow a user viewing the file 221 on a viewer device 107 to adjust a zoom level or navigate to a different portion of the file 221 than is displayed by the host application 216 only for a predetermined amount of time or until the host device 105 issues another navigation command 228 to the viewer application 223.

At step 503, the host application 216 can access a particular file 221 or document that is accessible to the host device 105 or a user account associated with the host device 105. At step 505, the host application 216 can determine a position within the file 221 to be rendered by the host application 216 upon accessing the file 221 and render the portion of the file 221 upon the display of the host device 105. At step 507, the host application 216 can generate a navigation command 228 instructing viewer devices 107 associated with the display sharing session to access a copy of the file 221 accessible to or stored on the viewer devices 107 and, in some scenarios, a particular position within the file 221 to which to navigate within the viewer application 226.

At step 509, the host application 216 can transmit the navigation command 228 to the viewer devices 107 associated with the display sharing session. Next, at step 511, the host application 216 can determine whether user input is received from the host device 105 from a user of the host device 105. If so, then the process can return to step 507, where a corresponding navigation command 228 can be generated and then transmitted to the viewer devices 107 at step 509. Otherwise, the host application 216 can determine whether the display sharing session is terminated by the user of the host device 105 at step 513. If so, then the process can proceed to completion at step 515 and the host application 216 can release any lock command. Otherwise, the process can return to step 511, where the host application 216 awaits user input from a user of the host device 105.

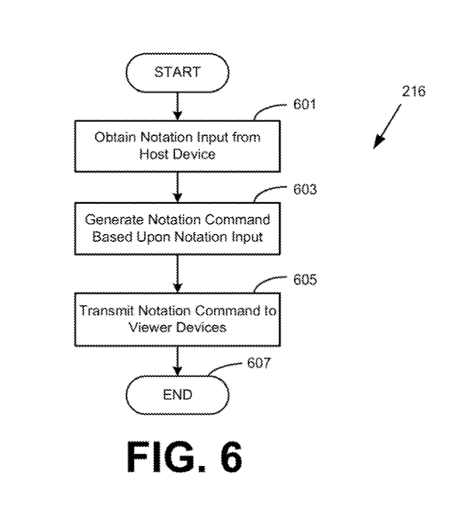

Referring next to FIG. 6, shown is a flowchart that provides one example of the operation of a portion of the host application 216 according to various embodiments. It is understood that the flowchart of FIG. 6 provides merely an example of the many different types of functional arrangements that can be employed to implement the operation of the portion of the host application 216 as described herein. As an alternative, the flowchart of FIG. 6 can be viewed as depicting an example of elements of a method implemented in the host device 105 according to one or more embodiments. Functionality attributed to the host application 216 can be implemented in a single process or application executed by the host device 105 and/or multiple processes or applications. The separation or segmentation of fiunctionality as discussed herein is presented for illustrative purposes only.

Beginning with step 601, the host application 216 can obtain notation input from a user of the host device 105. The host application 216 can obtain notation input by allowing a host user to enter a notation mode in which the host user can draw or enter notation text within the host application 216. The host application 216 can then obtain notation input from a user of the host device 105 from an input device associated with the host device 105, such as a touchscreen input device. At step 603, the host application 216 can generate a notation command corresponding to the notation input. For example, the host application 216 can generate a notation command that corresponds to notation of the content on the host device 105, such as gesture notation, text input, or other types of input. The notation input can be captured through a capability of the host application 216 that enables a user to draw or write using gestures, which the host application 216 can capture. The notation input can also be captured through another capability of the host application 216 that enables a user to enter text using a software or hardware keyboard, which the host application 216 can capture. Next, at step 605, the host application 216 can transmit the notation command 229 to the viewer devices 107 associated with the display sharing session. The host application 216 can transmit the notation command 229 to the viewer devices 107 through the network 209.

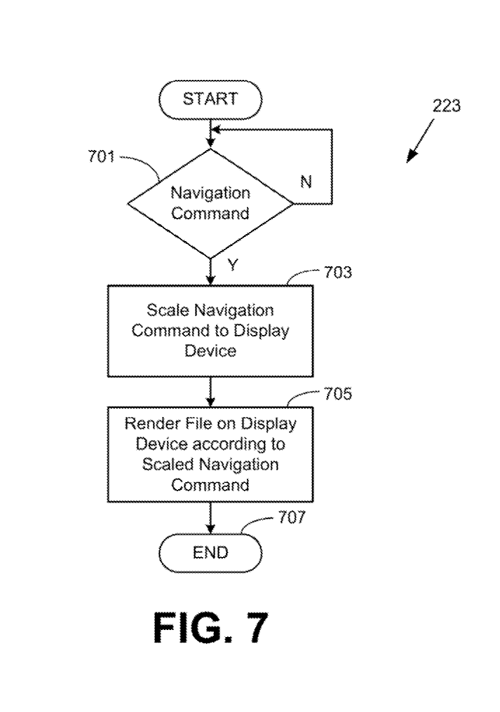

Referring next to FIG. 7, shown is a flowchart that provides one example of the operation of a portion of the viewer application 223 according to various embodiments. It is understood that the flowchart of FIG. 7 provides merely an example of the many different types of functional arrangements that can be employed to implement the operation of the portion of the viewer application 223 as described herein. As an alternative, the flowchart of FIG. 7 can be viewed as depicting an example of elements of a method implemented in a viewer device 107 according to one or more embodiments. Functionality attributed to the viewer application 223 can be implemented in a single process or application executed by a viewer device 107 and/or multiple processes or applications. The separation or segmentation of functionality as discussed herein is presented for illustrative purposes only.

Beginning with step 701, the viewer application 223 can determine whether a navigation command 228 is received from a host device 105 in association with a display sharing session. If so, then at step 703, the viewer application 223 can scale the parameters associated with the navigation command 228 to the display resolution of the viewer device 107 on which the viewer application 223 is executed. In some examples, a navigation command 228 may not require scaling to the display resolution of the viewer device 107, as an EMM environment can perform scaling of the parameters associated with a navigation command 228 based upon a known display resolution of the host device 105 and viewer device 107. The EMM can then transmit a navigation command 228 that does not require scaling to the viewer application 223. Next, at step 705, the viewer application 223 can render the file 221 associated with the display sharing session on a display of the viewer device 107 according to the scaled navigation command. The viewer application 223 can render the file 221 by navigating to another portion of the file 221 by an amount indicated by the navigation command 228. For example, the navigation command 228 can indicate that viewer application 223 should perform a “page-down” or a “page-up” operation. As another example, the navigation command 228 can indicate that the viewer application 223 can scroll in a certain direction by a certain amount. Thereafter, the process can proceed to completion at step 707.

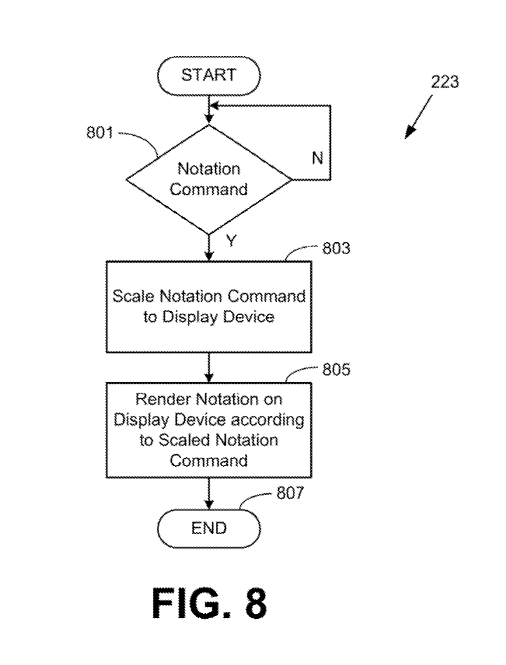

Referring next to FIG. 8, shown is a flowchart that provides one example of the operation of a portion of the viewer application 223 according to various embodiments. It is understood that the flowchart of FIG. 8 provides merely an example of the many different types of functional arrangements that can be employed to implement the operation of the portion of the viewer application 223 as described herein. As an alternative, the flowchart of FIG. 8 can be viewed as depicting an example of elements of a method implemented in a viewer device 107 according to one or more embodiments. Functionality attributed to the viewer application 223 can be implemented in a single process or application executed by a viewer device 107 and/or multiple processes or applications. The separation or segmentation of functionality as discussed herein is presented for illustrative purposes only.

Beginning with step 801, the viewer application 223 can determine whether a notation command 229 is received from a host device 105 in association with a display sharing session. If so, then at step 803, the viewer application 223 can scale the parameters associated with the notation command 229 to the display resolution of the viewer device 107 on which the viewer application 223 is executed. In some examples, a notation command 229 may not require scaling to the display resolution of the viewer device 107, as an EMM environment can perform scaling of the parameters associated with a notation command 229 based upon a known display resolution of the host device 105 and viewer device 107. The EMM environment can then transmit a notation command 229 that does not require scaling to the viewer application 223. Next, at step 805, the viewer application 223 can render the notation defined by the notation command 229 associated with the display sharing session on a display of the viewer device 107 according to the scaled notation command 229. For example, the viewer application 223 can render on the viewer device 107 a gesture or text input captured by and converted into a notation command 228 by the host device 105. Thereafter, the process can proceed to completion at step 807.

The host device 105 or viewer device 107 can include at least one processor circuit, for example, having a processor and at least one memory device, both of which are coupled to a local interface, respectively. Such a device can comprise, for example, at least one computer, a mobile device, smartphone, computing device or like device. The local interface can comprise, for example, a data bus with an accompanying address/control bus or other bus structure as can be appreciated.

Stored in the memory device are both data and several components that are executable by the processor. In particular, stored in the one or more memory devices and executable by the processor of such a device can be the host application 216 or viewer application 223 as well as potentially other applications. A number of software components are stored in the memory and are executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor, etc. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory can include both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, hard disk storage, etc. In such a case, a local interface can be an appropriate network that facilitates communication between any two of the multiple processors, between any processor and any of the memory devices, etc. The local interface can comprise additional systems designed to coordinate this communication, including, for example, performing load balancing. The processor can be of electrical or of some other available construction.

The host device 105 or viewer device 107 can include a display upon which a user interface generated by the host application 216 or viewer application 223, respectively, can be rendered. The host device 105 or viewer device 107 can also include one or more input/output devices that can include, for example, a capacitive touchscreen or other type of touch input device, fingerprint reader, keyboard, etc.

Although the host application 216 or viewer application 223 and other various systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagram and flowcharts show an example of the functionality and operation of an implementation of portions of components described herein. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as a processor in a computer system or other system. The machine code can be converted from the source code, etc. If embodied in hardware, each block can represent a circuit or a number of interconnected circuits to implement the specified logical function(s).

Although the sequence diagram flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the drawings can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that comprises software or code can be embodied in any non-transitory computer-readable medium for use by or in connection with an instruction execution system such as, for example, a processor in a computer system or other system. In this sense, the logic can comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, solid-state drives, flash memory, etc. Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices. Additionally, it is understood that terms such as “application,” “service,” “system,” “engine,” “module,” and so on can be interchangeable and are not intended to be limiting.

It is emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure.

Therefore, the following is claimed:

1. A non-transitory computer-readable medium embodying a program executable in a host device, the program, when executed by the host device, being configured to cause the host device to at least:
open a particular document on the host device;
determine a portion of the particular document viewable on a display of the host device; and
generate a navigation command with respect to the particular document, the navigation command causing at least one viewer device to render the portion of the particular document.

2. The non-transitory computer-readable medium of claim 1, wherein the program is further configured to cause the host device to at least initiate a display sharing session with the at least one viewer device.

3. The non-transitory computer-readable medium of claim 1, wherein the program is further configured to cause the host device to at least transmit the navigation command to the at least one viewer device.

4. The non-transitory computer-readable medium of claim 1, wherein the navigation command comprises a set of coordinates associated with the display of the host device.

5. The non-transitory computer-readable medium of claim 4, wherein the set of coordinates are expressed as a set of relative coordinates, a first one of the set of relative coordinates comprising a percentage of a first axis and a second one of the set of relative coordinates comprising a percentage of a second axis.

6. The non-transitory computer-readable medium of claim 1, wherein the navigation command comprises a zoom level associated with display of the particular document.

7. The non-transitory computer-readable medium of claim 1, wherein the navigation command comprises a vector corresponding to movement associated with display of the particular document or an indication of a display orientation of the host device.

8. The non-transitory computer-readable medium of claim 1, wherein the navigation command comprises a sequence number associated with the navigation command, the sequence number expressing an order of the navigation command relative to other navigation comments.

9. The non-transitory computer-readable medium of claim 7, wherein the movement is expressed in terms of an amount of movement relative to a display size of the display of the host device.

10. The non-transitory computer-readable medium of claim 1, the program being further configured to:
cause the host device to at least generate a notation command corresponding to notation of the particular document in response to a notation input; and
transmit the notation command to the at least one viewer device.

11. The non-transitory computer-readable medium of claim 10, wherein the notation command comprises at least one of a: stroke width, a stroke length, a stroke color or a text input.

12. A method, comprising:
initiating a display sharing session with a host device, the host device having access to a particular document and the viewer device having access to the particular document;
receiving, in the viewer device, a navigation command associated with viewing of the particular document; and
rendering, in the viewer device, a portion of the particular document on a display associated with the viewer device based at least in part upon the navigation command, the navigation command directing the viewer device to modify a display of the particular document on the viewer device.

13. The method of claim 12, wherein the viewer device and the host device store copies of the particular document.

14. The method of claim 12, further comprising disabling at least one of: an application switching capability of the viewer device or a display locking capability of the viewer device.

15. The method of claim 12, further comprising locking a display orientation of the viewer device.

16. The method of claim 12, further comprising verifying, in the viewer device, that a sequence number associated with the navigation command corresponds to an expected sequence number.

17. The method of claim 16, further comprising requesting, from the host device, a second navigation command corresponding to the sequence number in response to the sequence number failing to correspond to the expected sequence number.

18. The method of claim 12, further comprising receiving, in the viewer device, a notation command corresponding to a user input received by the host device, wherein the notation command corresponds to a notation of the particular document.

19. The method of claim 18, wherein the notation command comprises a stroke width, a shape, a stroke length, or a text input.

20. The method of claim 12, further comprising converting, in the viewer device, a parameter associated with the navigation command to a display size of the viewer device.

21. A non-transitory computer-readable medium embodying a program executable in a viewer device, the program, when executed by the viewer device, being configured to cause the viewer device to at least:
execute a display sharing session with a host device, the host device having access to a particular document and the viewer device being associated with a viewer user account having access to the particular document;
receive a navigation command associated with viewing of the particular document; and
render a portion of the particular document on a display associated with the viewer device based at least in part upon the navigation command.

22. The non-transitory computer-readable medium of claim 21, wherein the program is further configured to cause the viewer device to at least convert at least one parameter associated with the navigation command to a display resolution associated with the viewer device.

23. The non-transitory computer-readable medium of claim 21, wherein the navigation command corresponds to a gesture type obtained by the host device.

24. The non-transitory computer-readable medium of claim 23, wherein the gesture type corresponds to a tap, a rotation gesture, a pinch, an unpinch or a swipe.

25. The non-transitory computer-readable medium of claim 21, wherein the at least one parameter corresponds to a percentage of a host device display resolution and the at least one parameter is converted based upon the display resolution of the viewer device.
